(19) United States
(12) Patent Application Publication
(10) Pub. No.: US 2026/0244141 A1
(43) Pub. Date: Aug. 20, 2026

(54) IMAGE FORMING APPARATUS

(71) Applicant: Takahiro Kojima, Mishima Shizuoka (JP)

(72) Inventor: Takahiro Kojima, Mishima Shizuoka (JP)

(73) Assignee: ETRIA CO., LTD., Kanagawa (JP)

(21) Appl. No.: 19/286,227

(22) Filed: Jul. 30, 2025

(30) Foreign Application Priority Data
Feb. 18, 2025 (JP) 2025-024539

(51) Int. Cl. G03G 15/00; G03G 15/043

(52) U.S. Cl. CPC G03G 15/5054; G03G 15/043; G03G 15/5045; G03G 2215/00084

(57) ABSTRACT

An image forming apparatus includes a plurality of image forming units, an exposure unit, a transfer unit, and a processor. The plurality of image forming units forms an image obtained by developing the latent image formed on each of the photoreceptors with the developer supplied thereto. The exposure unit outputs light for forming a latent image on each of the photoreceptors in the plurality of image forming units. In a case where a difference between an environmental temperature and a temperature in the exposure unit from activation and a start of image formation satisfies a predetermined execution condition, the processor sets an alignment execution flag that instructs execution of the next position misalignment correction if a predetermined flag set time has elapsed from a first-cycle position misalignment correction after the activation.

### CROSS REFERENCE TO RELATED APPLICATIONS

This application is based upon and claims the benefit of priority from Japanese Patent Application No. 2025-024539, filed Feb. 18, 2025, the entire contents of which are incorporated herein by reference.

### FIELD

Embodiments described herein relate generally to an image forming apparatus.

### BACKGROUND

An electrophotographic image forming apparatus realizes color printing by superimposing images formed by toners of respective colors on each other. In such an image forming apparatus, image misalignment (color misalignment) in which images of respective colors to be superimposed are misaligned may occur. Examples of the cause of the image misalignment include displacement of each part due to the influence of a temperature change in an exposure apparatus (optical scanning apparatus). In a case where a temperature change in the exposure apparatus reaches a specific condition, the image forming apparatus executes position misalignment correction (alignment) for correcting an image misalignment. However, the conventional image forming apparatus has a problem that image misalignment is likely to occur even if a specific condition for executing position misalignment correction is not satisfied after the activation operation.

### BRIEF DESCRIPTION OF DRAWINGS

FIG. 1 is a diagram illustrating a configuration example of each unit in an image forming apparatus according to an embodiment.

FIG. 2 is a top view illustrating a configuration example of an exposure apparatus in the image forming apparatus according to the embodiment.

FIG. 3 is a bottom view illustrating a configuration example of an exposure apparatus in the image forming apparatus according to the embodiment.

FIG. 4 is a cross-sectional perspective view illustrating the configuration example of the exposure apparatus in the image forming apparatus according to the embodiment.

FIG. 5 is a diagram illustrating an installation example of an environment sensor and a dump heater in the image forming apparatus according to the embodiment.

FIG. 6 is a block diagram illustrating a configuration example of a control system in the image forming apparatus according to the embodiment.

FIG. 7 is a diagram illustrating a first example illustrating a relationship between temperature change and color misalignment of each unit in the image forming apparatus according to the embodiment.

FIG. 8 is a diagram illustrating a second example illustrating a relationship between temperature change and color misalignment of each unit in the image forming apparatus according to the embodiment.

FIG. 9 is a flowchart illustrating an operation example of alignment execution control after activation by the image forming apparatus according to the embodiment.

### DETAILED DESCRIPTION

According to an embodiment, an image forming apparatus includes a plurality of image forming units, an exposure unit, a transfer unit, and a processor. The plurality of image forming units forms an image obtained by developing the latent image formed on each of the photoreceptors with the developer supplied thereto. The exposure unit outputs light for forming a latent image on each of the photoreceptors in the plurality of image forming units. The transfer unit transfers a plurality of images developed by the plurality of image forming units with the developer to a medium in an overlapping manner. In a case where a difference between an environmental temperature and a temperature in the exposure unit from activation and a start of image formation satisfies a predetermined execution condition, the processor sets an alignment execution flag that instructs execution of the next position misalignment correction if a predetermined flag set time has elapsed from a first-cycle position misalignment correction after the activation.

Hereinafter, an image forming apparatus according to an embodiment will be described with reference to the drawings.

Note that, in each drawing used in the following description of the embodiment, a scale of each part may be appropriately changed. In addition, each drawing used for description of the following embodiments may be omitted for the sake of description.

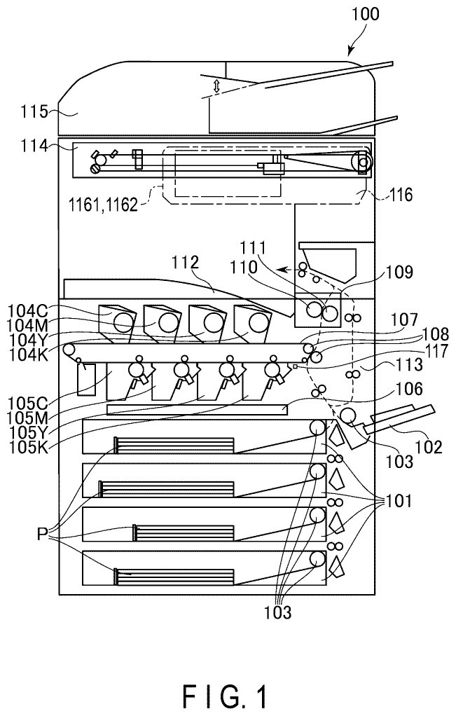

FIG. 1 is a diagram schematically illustrating a configuration example of an image forming apparatus 100 according to an embodiment.

The image forming apparatus 100 is disposed in a work place or the like. The image forming apparatus 100 performs printing by an electrophotographic method. The image forming apparatus 100 is, for example, a multifunction peripheral (MFP), a copier, a printer, a facsimile, or the like.

As illustrated in FIG. 1, the image forming apparatus 100 includes a sheet feeding tray 101, a manual feeding tray 102, a sheet feeding roller 103, a toner cartridge 104, an image forming unit 105, an exposure apparatus (exposure unit) 106, a transfer belt 107, a transfer roller 108, a fixing unit 109, a heating unit 110, a pressure roller 111, a sheet ejection tray 112, a double-sided unit 113, a scanner 114, a document feeding apparatus 115, a control panel 116, and the like.

The image forming unit 105 prints an image by an electrophotographic method. The image forming unit 105 forms an image to be printed on an image forming medium P or the like using toner. The image forming medium P is, for example, sheet-like paper (sheet). The scanner 114 reads an image from a document or the like on which an image is formed. For example, the image forming apparatus 100 realizes copying of an image of a document by printing the image read from the document by the scanner 114 on an image forming medium (hereinafter, referred to as a sheet) P by the image forming unit 105.

The sheet feeding tray 101 stores a sheet P as an image forming medium used for printing. The manual feeding tray 102 is a table for manually feeding the sheet P. The sheet feeding roller 103 is rotated by a motor to take out the sheet P stored in the sheet feeding tray 101 or the manual feeding tray 102 and supply the sheet P to a conveyance path. In the image forming apparatus 100, a sheet conveyance path is formed by a plurality of rollers and the like. The sheet P taken out by the sheet feeding roller 103 passes through a conveyance path and is supplied to a transfer position (secondary transfer position) to which an image is transferred.

The image forming apparatus 100 includes a plurality of toner cartridges 104. The toner cartridges 104 supply toner to the image forming unit 105. In the configuration example illustrated in FIG. 1, the image forming apparatus 100 includes four toner cartridges 104 including a toner cartridge 104C, a toner cartridge 104M, a toner cartridge 104Y, and a toner cartridge 104K. Each of the toner cartridge 104C, the toner cartridge 104M, the toner cartridge 104Y, and the toner cartridge 104K stores toner corresponding to each color of C, M, Y, and K (cyan, magenta, yellow, black (key)).

The color of the toner stored in the toner cartridges 104 is not limited to each color of CMYK, and may be other colors. The toner stored in the toner cartridge 104 may be a special toner. For example, the toner cartridge 104 may store a decolorable toner that decolors at a temperature higher than a predetermined temperature and becomes invisible.

The image forming apparatus 100 includes a plurality of image forming units 105. In the example illustrated in FIG. 1, the image forming apparatus 100 includes four image forming units 105 of an image forming unit 105C, an image forming unit 105M, an image forming unit 105Y, and an image forming unit 105K. The image forming unit 105C, the image forming unit 105M, the image forming unit 105Y, and the image forming unit 105K each receive toner corresponding to each color of CMYK and form a toner image (image) of each color.

Each of the image forming units 105 includes a developing device, a photosensitive drum (photoreceptor), and the like. An electrostatic latent image is formed on a surface of the photosensitive drum. The developing device develops the electrostatic latent image formed on the surface of the photosensitive drum using the toner supplied from the toner cartridge 104. As a result, a toner image formed with toner of each color is formed on the surface of the photosensitive drum of each image forming unit 105. Each image forming unit 105 transfers (primarily transfers) the toner image formed on the surface of the photosensitive drum onto the transfer belt 107 at each transfer position (primary transfer position).

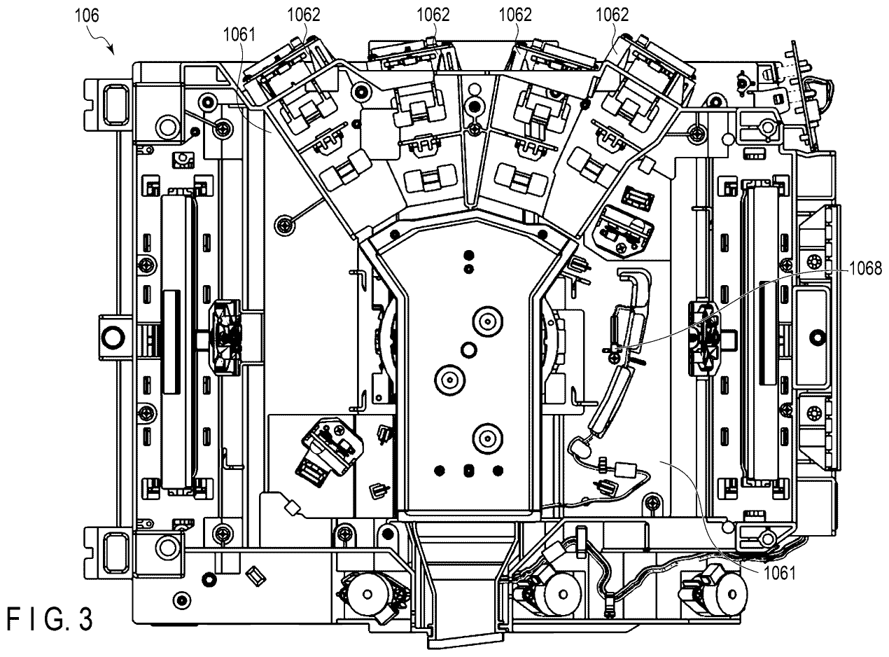

The exposure apparatus 106 is also called a laser scanning unit (LSU) or the like. The exposure apparatus 106 forms an electrostatic latent image on the surface of the photosensitive drum of each image forming unit 105 by laser light controlled according to image data. The exposure apparatus 106 is configured as illustrated in FIGS. 3 to 5 described later, for example.

The transfer belt 107 is, for example, an endless belt supported by a roller. The transfer belt 107 is configured such that one round has a predetermined length. The transfer belt 107 is rotated by the action of a roller. With the rotation of the transfer belt 107, an image is transferred (primarily transferred) by a transfer roller (primary transfer roller) of each of the image forming units 105C, 105Y, 105M, and 105K. The transfer belt 107 conveys the images (toner images) transferred from the image forming units 105C, 105Y, 105M, and 105K to the position (secondary transfer position) of the transfer roller 108.

The transfer roller 108 includes two rollers facing each other. The transfer roller 108 transfers (secondarily transfers) the image formed on the transfer belt 107 onto the image forming medium P passing between the transfer rollers 108.

The toner sensor 117 detects toner adhering to the transfer belt 107. The toner sensor 117 detects a toner image on the transfer belt 107 between a transfer position (primary transfer position) of the image forming unit 105K and a position (secondary transfer position) where the toner image on the transfer belt 107 corresponds to the transfer roller 108. For example, the toner sensor 117 is disposed so as to face the transfer belt 107 between the transfer roller of the image forming unit 105K and the transfer roller 108.

The fixing unit 109 heats and pressurizes the sheet P to which the image has been transferred. As a result, the image transferred onto the sheet P is fixed. The fixing unit 109 includes a heating unit 110 and a pressure roller 111 facing each other.

The heating unit 110 is, for example, a roller including a heat source for heating the heating unit 110. The heat source is, for example, a heater. The roller heated by the heat source heats the sheet P. The pressure roller 111 pressurizes the sheet P passing between the pressure roller 111 and the heating unit 110.

Furthermore, the heating unit 110 may include an endless belt suspended around a plurality of rollers. For example, the heating unit 110 includes a plate-like heat source, an endless belt, a belt conveyance roller, a tension roller, and a press roller. The endless belt is, for example, a film-shaped member. The belt conveyance roller drives the endless belt. The tension roller applies tension to the endless belt. An elastic layer is formed on a surface of the press roller. The plate-like heat source forms a fixing nip having a predetermined width with the press roller in a case where a heat generation portion side is in contact with an inner side of the endless belt and pressed toward the press roller. Since the plate-like heat source is configured to heat while forming a nip area, responsiveness at the time of energization is higher than that in the case of the heating method using the halogen lamp.

In the endless belt, for example, a silicon rubber layer having a thickness of 200 μm is formed on the outside of a steel use stainless (SUS) substrate having a thickness of 50 μm or polyimide which is a heat-resistant resin having a thickness of 70 μm, and the outermost periphery is covered with a surface protective layer such as perfluoroalkoxy alkane (PFA). In the press roller, for example, a silicon sponge layer having a thickness of 5 mm is formed on the surface of an iron bar having a diameter of 10 mm, and the outermost periphery is covered with a surface protective layer such as PFA. In the plate-like heat source, for example, a glaze layer and a heat generation resistance layer are stacked on a ceramic substrate. A heat sink made of aluminum is bonded to the plate-like heat source in order to release excessive heat to the opposite side and to prevent warpage of the substrate. The heat generation resistance layer contains a known material such as TaSiO2, for example, and is divided into a predetermined length and the number in a main scanning direction.

The sheet ejection tray 112 is a table on which the printed sheet P is ejected.

The double-sided unit 113 makes the sheet P printable on the back side. For example, the double-sided unit 113 reverses the front and back sides of the sheet P by switching back the sheet P using a roller or the like.

The scanner 114 reads an image from a document. The scanner 114 is an image reading apparatus for reading an image from a document. The scanner 114 is, for example, an optical reduction type image reading apparatus including an imaging element such as a charge-coupled device (CCD) image sensor. Furthermore, the scanner 114 may be a contact image sensor (CIS) type image reading apparatus including an imaging element such as a complementary metal-oxide-semiconductor (CMOS) image sensor.

The document feeding apparatus 115 is also called, for example, an auto document feeder (ADF). The document feeding apparatus 115 conveys documents placed on a document tray one after another. An image of the conveyed document is read by the scanner 114. The document feeding apparatus 115 may include a scanner for reading an image from a back surface of the document.

The control panel 116 is a device to be operated by an operator (user) of the image forming apparatus 100. The control panel 116 includes a display unit (display apparatus) 1161 and an operation unit (operation apparatus) 1162. The display unit 1161 is a display apparatus (display device) that displays a guide, an operation button, and the like. The display unit 1161 is, for example, a display such as a liquid crystal display or an organic EL display. The operation unit 1162 is an input unit (input device) to which the user inputs information. The operation unit 1162 includes, for example, a touch panel and a button. In the present embodiment, the control panel 116 includes a display apparatus with a touch panel as the display unit 1161 and the operation unit 1162.

Next, a configuration of the exposure apparatus (exposure unit) 106 in the image forming apparatus 100 according to the embodiment will be described.

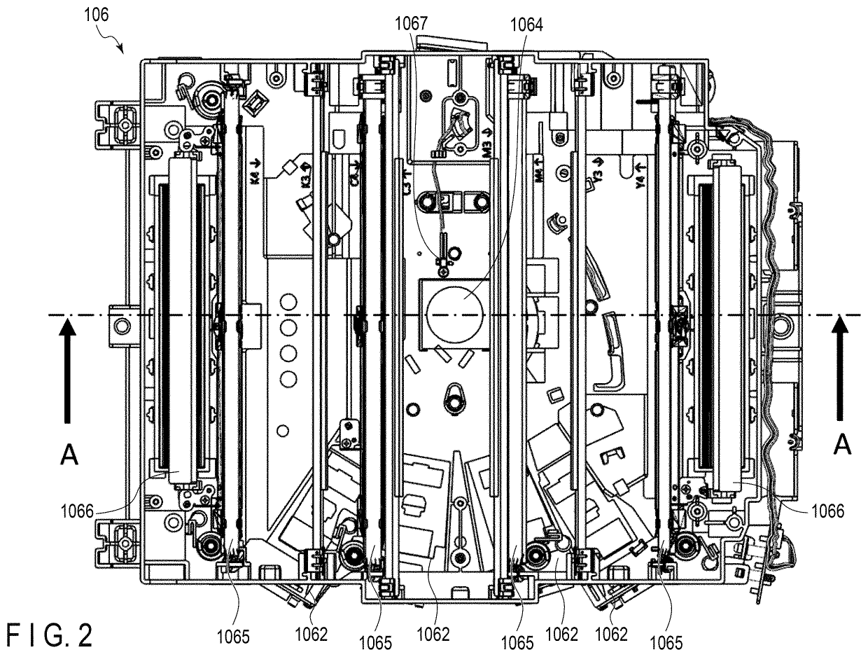

FIGS. 2 to 4 are diagrams illustrating configuration examples of the exposure apparatus 106 in the image forming apparatus 100 according to the embodiment.

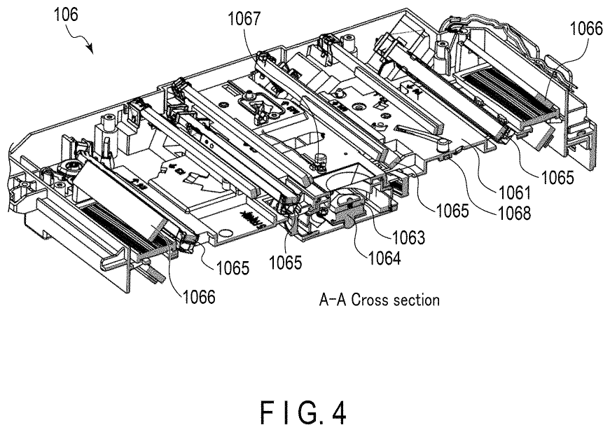

FIG. 2 is a top view illustrating an example of the exposure apparatus 106 in the image forming apparatus 100 according to the embodiment. FIG. 3 is a bottom view illustrating an example of the exposure apparatus 106 in the image forming apparatus 100 according to the embodiment. FIG. 4 is a cross-sectional perspective view illustrating an example of the exposure apparatus 106 in the image forming apparatus 100 according to the embodiment.

As illustrated in FIGS. 3 to 5, the exposure apparatus 106 includes a housing 1061, a laser unit 1062, a polygon mirror 1063, a polygon motor 1064, a mirror 1065, a lens 1066, a first thermistor (first temperature sensor) 1067, and a second thermistor (second temperature sensor) 1068.

The housing 1061 is a housing that houses the laser unit 1062, the polygon mirror 1063, the polygon motor 1064, the mirror 1065, the lens 1066, the first thermistor 1067, and the second thermistor 1068. The housing 1061 supports the laser unit 1062, the polygon mirror 1063, the polygon motor 1064, the mirror 1065, the lens 1066, the first thermistor 1067, and the second thermistor 1068. The housing 1061 is made of resin, for example.

The exposure apparatus 106 includes a laser unit 1062C, a laser unit 1062M, a laser unit 1062Y, and a laser unit 1062K as the laser unit 1062. The laser units 1062C, 1062M, 1062Y, and 1062K correspond to the image forming units 105C, 105M, 105Y, and 105K, respectively. Each laser unit 1062 emits a laser beam. Each laser unit 1062 controls emission of laser light according to a control signal corresponding to an image formed by the corresponding image forming unit 105. For example, each laser unit 1062 modulates laser light according to a control signal corresponding to image data.

The polygon mirror 1063 reflects the laser beam emitted from each laser unit 1062. The polygon mirror 1063 rotates by the polygon motor 1064 to polarization-scan with each laser beam. The polygon motor 1064 is a motor that rotates the polygon mirror 1063. The polygon motor 1064 generates heat while rotating the polygon mirror 1063, and thus can be a heat source in the exposure apparatus 106.

The mirror 1065 and the lens 1066 are optical elements for scanning the photosensitive drums of the image forming units 105 with laser light. For example, the mirror 1065 is provided so as to be adjustable in position, angle, or the like with respect to the housing 1061.

The first thermistor 1067 is an example of a temperature sensor (temperature detection unit) that detects a temperature near a central portion (first portion) in exposure apparatus 106. The first thermistor 1067 outputs a signal indicating the measured temperature. The first thermistor 1067 is installed in the vicinity of the polygon motor 1064 in the central portion of the housing 1061 in the configuration example illustrated in FIGS. 3 to 5 described later.

The second thermistor 1068 is an example of a temperature sensor (temperature detection unit) that detects a temperature near an end portion (second portion) in the exposure apparatus 106. The second thermistor 1068 outputs a signal indicating the measured temperature. The second thermistor 1068 detects the temperature of a second portion farther from the polygon motor 1064 than the first portion in the exposure apparatus 106. In the example shown in FIGS. 3 to 5, the second thermistor 1068 is installed near a midpoint between an end of the housing 1061 and the polygon motor 1064. In this case, the second thermistor 1068 is installed at a position farther from the polygon motor 1064 than the first thermistor 1067.

Next, an environment sensor 211 and dump heaters 221 and 222 installed in the image forming apparatus 100 according to the embodiment will be described.

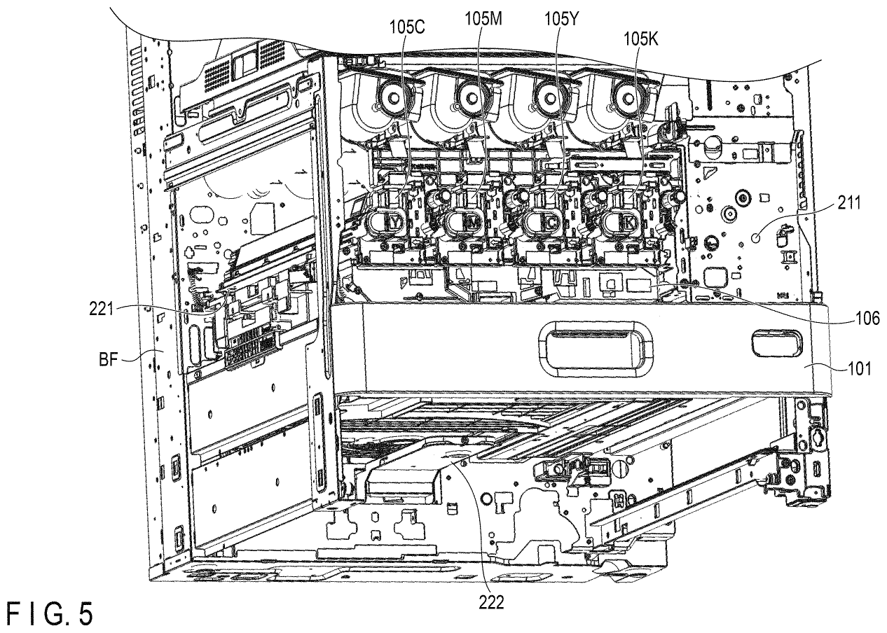

FIG. 5 is a diagram illustrating an installation example of the environment sensor 211 and the dump heaters 221 and 222 in a body frame (housing) BF of the image forming apparatus 100 according to the embodiment.

The environment sensor 211 includes a sensor that detects a temperature in an installation environment of the image forming apparatus 100. The environment sensor 211 is disposed at a position where a temperature in the housing EF of the image forming apparatus 100 can be detected. In the configuration example illustrated in FIG. 5, the environment sensor 211 is installed at a position away from the dump heaters 221 and 222. The environment sensor 211 is disposed so as not to be affected by a local temperature rise due to heat generated by the dump heaters 221 and 222.

The dump heaters 221 and 222 are heaters for preventing dew condensation on a sheet in the housing BF or on a photosensitive drum in the image forming unit 105. The dump heaters 221 and 222 operate in a case where the main power supply of the image forming apparatus 100 is turned off (hereinafter, power-off) and the temperature falls below a set temperature. For example, the dump heaters 221 and 222 have a configuration in which the heaters are connected to a thermostat that operates if the temperature becomes equal to or lower than a set temperature in a power-off state. In the dump heaters 221 and 222, if the thermostat operates below the set temperature, a current flows through the heaters to warm the periphery of the heaters.

The dump heaters 221 and 222 are disposed in the vicinity of the sheet feeding cassette and the photosensitive drum in order to prevent dew condensation on the sheet and the photoreceptor. For example, the dump heater 221 is arranged in the vicinity of the image forming unit 105 including the photosensitive drum in the configuration example illustrated in FIG. 5. The image forming apparatus 100 has a structure as an electrophotographic printer, and the exposure apparatus 106 is disposed in the vicinity of the photoreceptor. Therefore, the dump heater 221 for preventing dew condensation on the photosensitive drum is disposed in the vicinity of the exposure apparatus 106.

Furthermore, in the configuration example illustrated in FIG. 5, the dump heater 222 is arranged in the vicinity of a sheet feeding tray (sheet feeding cassette) 101 that stores sheets. In the configuration illustrated in FIGS. 1 and 5, the exposure apparatus 106 is disposed on an upper portion of the sheet feeding tray 101 that stores sheets. In the image forming apparatus 100 having such a configuration, the dump heater 222 for preventing dew condensation on a sheet is also arranged in the vicinity of the exposure apparatus 106.

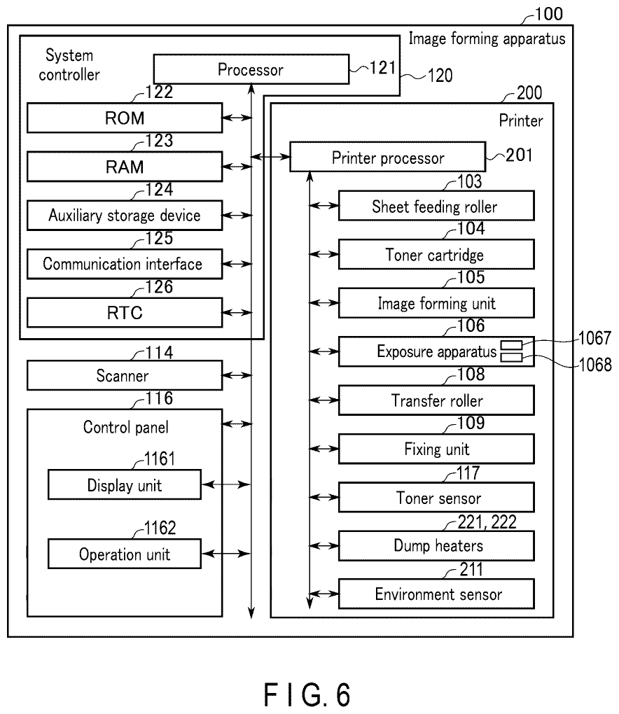

Next, a configuration of a control system in the image forming apparatus 100 according to the embodiment will be described. FIG. 6 is a block diagram illustrating a configuration example of a control system in the image forming apparatus 100 according to the embodiment.

In the configuration example illustrated in FIG. 6, the image forming apparatus 100 includes a system controller 120, a scanner 114, a control panel 116, and a printer 200. The system controller 120 includes a processor 121, a read-only memory (ROM) 122, a random-access memory (RAM) 123, an auxiliary storage device 124, a communication interface 125, a real-time clock (RTC) 126, a scanner 114, a control panel 116, and the printer 200.

The processor 121 corresponds to a central part of a computer that performs processing such as calculation and control necessary for the operation of the image forming apparatus 100. The processor 121 controls each unit to implement various functions of the image forming apparatus 100 based on a program such as system software, application software, or firmware stored in the ROM 122, the auxiliary storage device 124, or the like.

The processor 121 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), a field-programmable gate array (FPGA), or the like. Alternatively, the processor 121 is a combination of a plurality of these.

The ROM 122 corresponds to a main storage apparatus of a computer mainly including the processor 121. The ROM 122 is a nonvolatile memory exclusively used for reading data. The ROM 122 stores the above program. In addition, the ROM 122 stores data, various setting values, or the like used in a case where the processor 121 performs various processing.

The RAM 123 corresponds to a main storage apparatus of a computer centered on the processor 121. The RAM 123 is a memory used to read and write data. The RAM 123 is used as a so-called work area or the like in which data temporarily used in a case where the processor 121 performs various processing is stored.

The auxiliary storage device 124 corresponds to an auxiliary storage apparatus of a computer centered on the processor 121. The auxiliary storage device 124 is, for example, an electric erasable programmable read-only memory (EEPROM) (registered trademark), a hard disk drive (HDD), a solid state drive (SSD), or the like. The auxiliary storage device 124 may store a program. In addition, the auxiliary storage device 124 stores data used in a case where the processor 121 performs various types of processing, data generated by processing in the processor 121, various types of setting information, and the like. For example, the auxiliary storage device 124 is a memory that stores, as various types of setting information, execution conditions of guidance of image misalignment (thresholds for a difference between the temperature of the exposure apparatus and the environmental temperature), guidance execution time, guidance end time, and the like.

Note that the image forming apparatus 100 may include an interface into which a storage medium such as a memory card or a universal serial bus (USB) memory can be inserted instead of the auxiliary storage device 124 or in addition to the auxiliary storage device 124.

The program stored in the ROM 122 or the auxiliary storage device 124 includes a program for executing processing to be described later. As an example, the image forming apparatus 100 is transferred to an administrator or the like of the image forming apparatus 100 in a state where the program is stored in the ROM 122 or the auxiliary storage device 124. The image forming apparatus 100 may be transferred to an administrator or the like in a state where the program is not stored in the ROM 122 or the auxiliary storage device 124.

In addition, a program for executing processing to be described later may be written in the ROM 122 or the auxiliary storage device 124 by an operation by an administrator, a service person, or the like. The transfer of the program can be realized, for example, by recording the program in a removable storage medium such as a magnetic disk, a magneto-optical disk, an optical disk, or a semiconductor memory, or by downloading the program via a network or the like.

The communication interface 125 is an interface for the image forming apparatus 100 to communicate via a network or the like. The communication interface 125 is connected to a terminal apparatus operated by a user.

The RTC 126 is a clock or a circuit incorporating a clock function. For example, the processor 121 counts an elapsed time from a specific time using the RTC 126.

Note that the system controller 120 may include a display apparatus as an external apparatus and an interface connected to an operation apparatus. In this case, the processor 121 may display a guide of image misalignment to be described later on a display apparatus as an external apparatus connected via an interface.

The printer 200 prints an image on an image forming medium (sheet) P or the like based on the image data. In the printer 200, in the configuration example illustrated in FIG. 2, a printer processor 201 is connected with the sheet feeding roller 103, the toner cartridge 104, the image forming unit 105, the exposure apparatus 106, the transfer roller 108, the fixing unit 109, the toner sensor 117, the environment sensor 211, and the dump heaters 221 and 222. However, the environment sensor 211 and the dump heaters 221 and 222 may be connected to the processor 121 of the system controller 120 without the printer processor 201.

The printer processor 201 performs processing such as calculation and control necessary for a print operation of the image forming apparatus 100 in order to realize a print function. The printer processor 201 performs processing such as calculation and control necessary for the print operation based on instructions and the like from the processor 121 and various programs. Further, the printer processor 201 outputs a processing result and the like to the processor 121.

Note that the various programs may be stored in a storage unit such as the ROM 122 or the auxiliary storage device 124, or may be incorporated in a circuit of the printer processor 201. Furthermore, a storage unit provided in the printer 200 may store various programs. The printer processor 201 is, for example, a CPU, an MPU, an SoC, a DSP, a GPU, an ASIC, a PLD, an FPGA, or the like.

Next, position misalignment correction (color misalignment correction) for correcting the misalignment of the image in the image forming apparatus 100 according to the embodiment will be described.

In the image forming apparatus 100, in the exposure apparatus 106, a misalignment may occur in an exposure position due to minute deformation caused by a change in a temperature state or the like. The image forming apparatus 100 has a function of executing position misalignment correction for correcting a misalignment of an image due to a misalignment of an exposure position by the exposure apparatus 106 or the like.

The image forming apparatus 100 generates a color image by superimposing images (toner images of respective colors) formed by the plurality of image forming units 105 with toners of a plurality of colors. Therefore, the image forming apparatus 100 needs to adjust the misalignment of the toner image of each color in color printing. Such position misalignment correction in color printing is also referred to as color misalignment correction (color registration). The color misalignment correction is performed under the control of the processor 121 or the printer processor 201 in a case where a color image is executed.

For example, the processor 121 forms a predetermined pattern for measuring the misalignment of the image of each color formed by the toner of each color on the transfer belt 107 as the color misalignment correction. The processor 121 detects the misalignment amount from an ideal position (reference position) for the image of each color by a predetermined pattern on the transfer belt 107. The processor 121 corrects the positional misalignment of the image of each color by changing an exposure timing or the like by the exposure apparatus 106 based on the misalignment amount. Specifically, the processor 121 calculates a relative positional misalignment between a conveyance direction and a scanning direction in the image of each color from the reading result of the predetermined pattern. As a result, the processor 121 adjusts an exposure timing for forming the images of the respective colors so that the image patterns of the respective colors (four colors) overlap according to the calculated positional misalignment.

The image forming apparatus 100 executes position misalignment correction (color misalignment correction) in a case of detecting that a predetermined condition for executing position misalignment correction has been reached. The execution condition of the position misalignment correction is set for the temperature in the exposure apparatus 106. For example, the image forming apparatus 100 is set so as to execute position misalignment correction according to a change in temperature in the exposure apparatus 106 detected by the first thermistor 1067 and the second thermistor 1068. In addition, the image forming apparatus 100 executes position misalignment correction in the activation operation executed in a case where a main power is turned on. Further, the image forming apparatus 100 may be set to execute the position misalignment correction in a case of executing color printing first after the activation operation. In the present embodiment, it is assumed that the image forming apparatus 100 executes position misalignment correction in the activation operation.

Next, an influence on the exposure apparatus 106 by turning on and off the dump heaters 221 and 222 during power-off in the image forming apparatus 100 will be described.

In the present embodiment, power-off is a state in which the main power of the image forming apparatus 100 is off. The power-off image forming apparatus 100 is in a state (operation stop state) in which various operations (jobs) such as printing and scanning are stopped and an operation instruction other than an operation instruction for turning on the main power is not received although the power-off image forming apparatus 100 is connected to an external power supply.

The dump heaters 221 and 222 are connected to be able to supply power from an external power supply even in a power-off state. Therefore, the image forming apparatus 100 does not receive various operations in the power-off state, but the dump heaters 221 and 222 can operate. The power-off period is also referred to as an operation stop period. The image forming apparatus 100 in a power-off state executes the activation operation in response to an instruction to turn on the main power (activation instruction). It is assumed that the image forming apparatus 100 is in a state in which jobs such as printing and scanning can be executed after the activation operation.

In the configuration example illustrated in FIG. 5, the dump heaters 221 and 222 are disposed near the photoreceptor and the sheet feeding cassette. If the dump heaters 221 and 222 are turned on during power-off, not only the photoreceptor and the sheet feeding cassette but also the exposure apparatus 106 is warmed. The state of the exposure apparatus 106 may be different even after the activation operation depending on whether the dump heaters 221 and 222 are turned on during power-off. In the exposure apparatus 106, the exposure position may be changed by minute deformation according to a temperature distribution in the housing 1061, and the misalignment (color misalignment) of the image may occur. That is, in the image forming apparatus 100 according to the embodiment, depending on whether the dump heaters 221 and 222 are turned on during power-off, the state of the image misalignment after the activation operation may vary.

Next, a change in state after activation in the image forming apparatus 100 according to the embodiment will be described.

In the image forming apparatus 100, the occurrence state of the image misalignment varies depending on whether the dump heaters 221 and 222 are turned on during power-off before activation. Here, as an operation example of the image forming apparatus 100, it is assumed that the main power is turned on during the day to make printing operable, and the main power is turned off at night to stop the printing operation. In the image forming apparatus 100 operated as described above, the state of image misalignment after activation changes depending on whether the dump heaters 221 and 222 operate during a power-off period (operation stop period) at night.

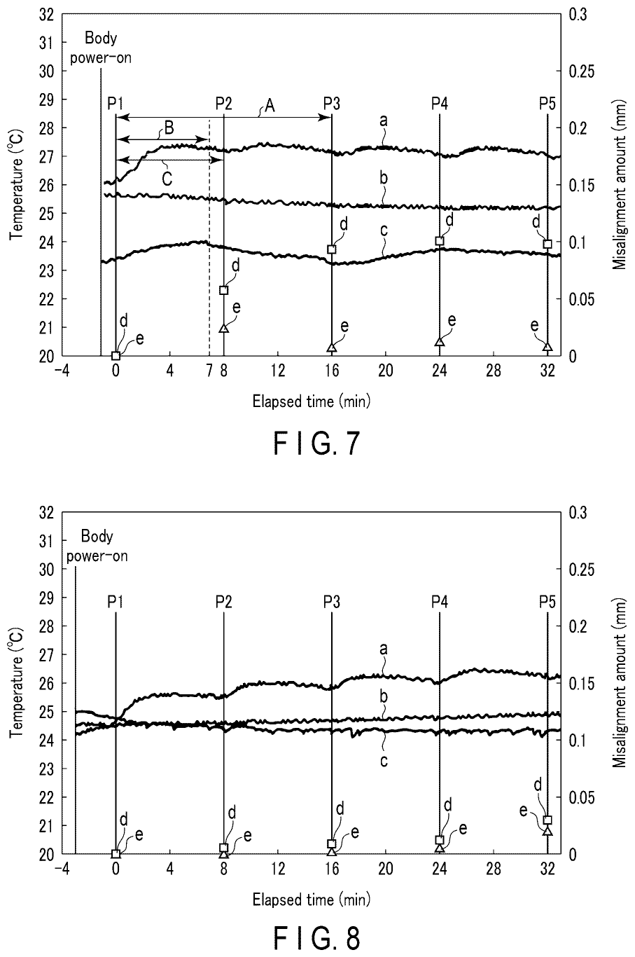

FIGS. 7 and 8 are diagrams illustrating a temperature of each unit and a measurement value of the image misalignment in a case where the image forming apparatus 100 activated from the power-off state (operation stop period) executes print processing at a specific print interval.

FIG. 7 is a diagram illustrating a temperature of each unit after activation and a measurement value of an image misalignment in a case where the dump heaters 221 and 222 operate (turn on) during an operation stop period (a case where the heaters are turned on). FIG. 8 is a diagram illustrating a temperature of each unit after activation and a measurement value of an image misalignment in a case where the dump heaters 221 and 222 do not operate (turn on) during an operation stop period (a case where the heaters are turned off).

In FIGS. 7 and 8, it is assumed that the operation stop period is 14 hours, the print interval is every 8 minutes, and the content of the print processing is color printing on two A3 size sheets. FIGS. 7 and 8 illustrate measurement results in a case where activation processing (activation operation) after the operation stop period is executed according to the power-on in the power-off state and the position misalignment correction is executed immediately before first printing. However, it is assumed that the dump heaters 221 and 222 are turned off at the same time as the power is turned on.

In FIGS. 7 and 8, a detection temperature a of the first thermistor 1067 and a detection temperature b of the second thermistor 1068 are illustrated as the temperature of the exposure apparatus (exposure unit) (the temperature in the housing 1061 of the exposure apparatus 106). In addition, FIGS. 7 and 8 illustrate a detection temperature c of the environment sensor 211 as the environmental temperature. Further, FIGS. 7 and 8 illustrate the measurement value of the image misalignment appearing on the sheet printed in color by the image forming apparatus 100 as the measurement value of the image misalignment. In FIGS. 7 and 8, a measurement value d of the image misalignment in the main scanning direction is indicated by square points, and a measurement value e of the image misalignment in the sub-scanning direction is indicated by triangle points.

First, the temperature in the housing 1061 of the exposure apparatus 106 immediately after power-on (the temperature of the exposure apparatus) is compared with the environmental temperature.

Here, the detection temperature a of the first thermistor 1067 is a temperature of the central portion of the housing 1061 in the vicinity of the polygon motor 1064 in the exposure apparatus 106. The detection temperature b of the second thermistor 1068 is a temperature of an end portion of the housing 1061 at a position away from the polygon motor 1064 in the exposure apparatus 106. The temperature of the exposure apparatus (exposure unit) may be either the detection temperature of the first thermistor 1067 or the detection temperature of the second thermistor 1068, or may be an average value of the detection temperature of the first thermistor 1067 and the detection temperature of the second thermistor 1068.

In the example shown in FIG. 8, immediately after power-on, differences of the detection temperature a of the first thermistor 1067, the detection temperature b of the second thermistor 1068, and the detection temperature c of the environment sensor 211 are 1 degree or less. In consideration of the measurement accuracy of the first and second thermistors 1067 and 1068 and the environment sensor 211, in the example illustrated in FIG. 8, it can be said that the temperature of the exposure apparatus is substantially equal to the environmental temperature immediately after power-on. Accordingly, in a case where the dump heaters 221 and 222 do not operate during power-off (in a case where the heater is turned off), it is considered that the temperature of the exposure apparatus and the environmental temperature become substantially equal immediately after power-on.

In the example shown in FIG. 7, immediately after power-on, the detection temperature a of the first thermistor 1067 and the detection temperature b of the second thermistor 1068 are higher than the detection temperature c of the environment sensor 211. As a result, in a case where the dump heaters 221 and 222 operate during power-off (in a case where the heaters are on), it is considered that the temperature of the exposure apparatus is higher than the environmental temperature immediately after power-on.

Next, a change in temperature of each part after starting of the printing operation will be described.

In the example shown in FIG. 8, both the detection temperature a of the first thermistor 1067 and the detection temperature b of the second thermistor 1068 tend to rise after starting of the printing operation. A portion of the housing 1061 where the temperature rises tends to physically expand. That is, it is considered that the entire housing 1061 expands in the exposure apparatus 106 since the temperatures of the central portion and the end portion of the housing 1061 increase in a case where the heaters are off during power-off. In a case where the entire housing 1061 expands, the deformation amount of the entire housing 1061 becomes relatively small as compared with a case where the central portion of the housing 1061 expands and the end portion contracts. As a result, the exposure apparatus 106 is considered to reduce the image misalignment in printing after the activation operation (after position misalignment correction before first printing).

In the example shown in FIG. 7, after starting of the printing operation, the detection temperature a of the first thermistor 1067 tends to increase, and the detection temperature b of the second thermistor 1068 tends to decrease. The detection temperature a of the first thermistor 1067 tends to rise because the polygon motor 1064 in the central portion of the housing 1061 is driven to generate heat. The detection temperature b of the second thermistor 1068 tends to decrease because the end portion of the housing 1061 is cooled by a temperature difference from the environmental temperature. Although the heat generated by the polygon motor 1064 is transferred to the end portion of the housing 1061, it is considered that the temperature tends to decrease due to a large temperature difference from the environmental temperature.

In FIG. 7, an image misalignment in printing after the activation operation is indicated by points d and points e. As illustrated in FIG. 7, in a case where the heaters are turned on during power-off, in printing after the activation operation (after the first position misalignment correction), the image misalignment increases along with a temperature rise at the central portion of the housing 1061 and a temperature drop at the end portion. Such image misalignment is considered to occur in a case where the central portion of the housing 1061 expands due to an increase in temperature and the end portion contracts due to a decrease in temperature. If the expansion of the central portion and the contraction of the end portion occur at the same time, the deformation amount of the entire housing 1061 becomes relatively large as compared with the case where the entire housing 1061 expands. It is considered that if the deformation amount of the housing 1061 increases, the exposure apparatus 106 increases the misalignment of the exposure position, and the misalignment of the image (image of each color) formed on the medium increases.

If FIG. 7 and FIG. 8 are compared with each other, it is apparent that the amount of change per unit time of the image misalignment is larger in a case where the heater is turned on during power-off. In the example shown in FIG. 7, in the printing every 8 minutes after the activation operation, a change amount (increase amount) of the image misalignment increases from the first printing to the third printing (16 minutes). However, in the example shown in FIG. 7, the temperature at the central portion of the housing 1061 hardly changes after rising immediately after the first printing, and the time change of the temperature at the end portion of the housing 1061 is also small.

In the temperature change illustrated in FIG. 7, it is difficult to perform setting such that position misalignment correction is executed under a temperature condition with respect to a temperature difference between the temperature of the central portion and the temperature of the end portion (a temperature difference between the detection temperature of the first thermistor 1067 and the detection temperature of the second thermistor 1068). If the position misalignment correction is set to be executed even if the temperature difference between the central portion and the end portion is small, a highly accurate thermistor is required, and the position misalignment correction is frequently executed and the printing operation is delayed.

Therefore, the image forming apparatus 100 according to the embodiment performs setting so as to execute position misalignment correction by focusing on the change in the image misalignment as illustrated in FIG. 7.

In the example illustrated in FIG. 7, the change in the image misalignment is large in a period (A) from a first printing (0 minute) to a third printing (16 minutes) after power-on, and is small after the third printing. Furthermore, the change amount of the image misalignment is large (0.05 mm or more) between the image misalignment amount at the first printing and the image misalignment amount at the second printing. Therefore, according to the example illustrated in FIG. 7, in order to make the image misalignment less than 0.05, it is necessary to perform position misalignment correction (second position misalignment correction) before the second printing (color printing). If the position misalignment correction is executed before the second color printing, the image misalignment can be reduced in the second and subsequent color printing.

However, in the image forming apparatus 100 according to the embodiment, image misalignment does not occur in single-color printing, and image misalignment occurs in color printing in which images of a plurality of colors are superimposed. That is, the image forming apparatus 100 does not need to execute position misalignment correction in a case where color printing is not executed. Therefore, the image forming apparatus 100 sets a flag (alignment execution flag) for executing the position misalignment correction immediately before the color printing at a timing before the color printing that requires the second position misalignment correction is executed. If the alignment execution flag is set in starting the color printing, the image forming apparatus 100 executes the position misalignment correction immediately before executing the color printing.

In the example illustrated in FIG. 7, in order to set the position misalignment correction to be executed immediately before the second color printing, the alignment execution flag may be set at a timing (B) before the second color printing is executed. As a specific example, since the second color printing in which the image misalignment becomes large is 8 minutes (C) after the first printing, it is conceivable to set the alignment execution flag 7 (8-1) minutes (B) after the first printing (first printing with position misalignment correction) which is the timing one minute before the second color printing.

The timing of setting the alignment execution flag (after 7 minutes from the first printing in the example of FIG. 7) B is set within a period (0 to 16 minutes in the example of FIG. 7) A in which the change in the image misalignment becomes large and before the time (0 to 8 minutes in the example of FIG. 7) C in which the change in the image misalignment becomes larger than that in the first printing (for example, one minute before).

The image forming apparatus 100 according to the embodiment defines in advance a period (alignment control period) A in which a change in image misalignment after activation increases, a timing (flag set time) B at which the second alignment execution flag is set, and a time (flag settable period) C at which the alignment execution flag can be set. As a result, the image forming apparatus 100 can set the alignment execution flag at a timing B from the first color printing (first position misalignment correction) after activation, and can execute the position misalignment correction before the second color printing in which the image misalignment becomes large.

Next, an operation example of the position misalignment correction control after the activation operation by the image forming apparatus 100 according to the embodiment will be described.

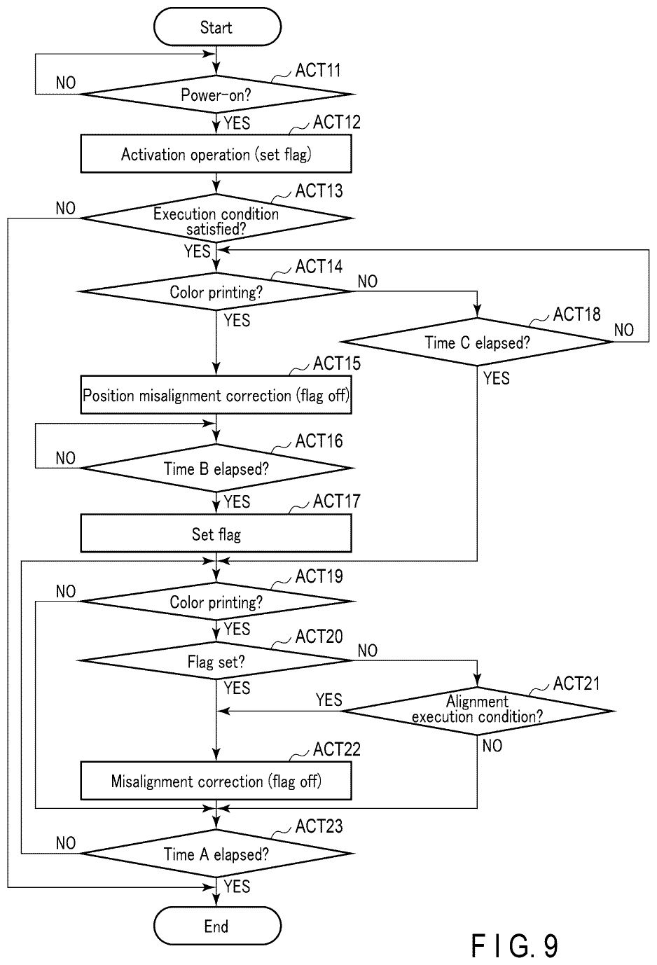

FIG. 9 is a flowchart illustrating an operation example of position misalignment correction control after the activation operation by the image forming apparatus 100 according to the embodiment.

As described above, in the image forming apparatus 100, the dump heaters 221 and 222 operate if the temperature becomes equal to or lower than a predetermined temperature in the power-off state (operation stop period).

The processor 121 of the image forming apparatus 100 receives a power-on signal in a power-off state. For example, in a case where a main power button provided in the image forming apparatus 100 is pressed, a power on signal is input to the processor 121. In a case where a power-on instruction is input (ACT11, YES), the processor 121 executes the activation operation, and sets the alignment execution flag that instructs the execution of the position misalignment correction immediately before the first color printing (ACT12).

In addition, the processor 121 determines whether an execution condition of alignment execution control after activation (predetermined period A) is satisfied in the activation operation in response to power-on (ACT13). The processor 121 determines whether to perform alignment execution control of after activation depending on whether preset execution conditions are satisfied. The execution condition includes a condition for determining whether the dump heaters 221 and 222 are turned on during the power-off state (operation stop period).

For example, the processor 121 determines, as an execution condition, whether a difference between the temperature of the exposure apparatus and the environmental temperature during a period from immediately after power-on to the start of first printing is equal to or more than a predetermined threshold. The predetermined threshold value is set according to the heater capacity of the dump heaters 221 and 222, the structure of the machine body, the accuracy of the first and second thermistors, and the like. As a specific example, referring to the measurement result illustrated in FIG. 7, the predetermined threshold is set to a value around 2° C.

In the case of calculating the difference between the temperature of the exposure apparatus and the environmental temperature, the processor 121 acquires information indicating the temperature from each sensor immediately after power-on. That is, the processor 121 acquires information indicating the detection temperature from each of the first thermistor 1067, the second thermistor 1068, and the environment sensor 211.

The processor 121 sets the detection temperature of the environment sensor 211 as the environmental temperature, and sets the detection temperatures of the first thermistor 1067 and the second thermistor 1068 as the temperature of the exposure apparatus. However, the processor 121 may set the detection temperature of either the first thermistor 1067 or the second thermistor 1068 as the temperature of the exposure apparatus, or may set an average value of the detection temperature of the first thermistor 1067 and the detection temperature of the second thermistor 1068 as the temperature of the exposure apparatus. Upon acquiring the temperature of the exposure apparatus and the environmental temperature, the processor 121 calculates a difference value by subtracting the environmental temperature from the temperature of the exposure apparatus, and determines whether the calculated difference value is a predetermined threshold or more.

Note that the determination as to whether the execution condition of the execution control of the alignment is satisfied is not limited to the determination based on the difference between the temperature of the exposure apparatus and the environmental temperature. For example, it may be determined whether to perform the execution control of the alignment by directly detecting whether the dump heaters 221 and 222 are turned on during the power-off state at the time of activation. As a specific example, the image forming apparatus 100 may be provided with a recording unit that records that the dump heaters 221 and 222 are turned on during power-off. In this case, the processor 121 may determine whether the dump heaters 221 and 222 operate while the power supply is turned on according to the recorded content of the recording unit.

In a case where the processor 121 determines that the execution condition is not satisfied, that is, the execution control of the alignment after the activation is not performed (ACT13, NO), the processor 121 proceeds to the normal operating state after the activation. As a result, if the dump heaters 221 and 222 are not turned on during power-off, the processor 121 can proceed to a normal operation state without performing the alignment execution control after activation.

In a case of determining that the execution condition of the alignment execution control is satisfied (ACT13, YES), the processor 121 starts the alignment execution control in a predetermined period A after activation while executing the normal print processing. Upon starting the alignment execution control, the processor 121 determines whether color printing has been accepted (ACT14). If there is no instruction for color printing (ACT14, NO), the processor 121 proceeds to ACT18.

In a case of receiving the first color printing (ACT14, YES), the processor 121 executes the position misalignment correction and turns off the alignment execution flag (ACT15). At the time of the first color printing, the alignment execution flag set at the time of the activation operation is set. Therefore, the processor 121 performs position misalignment correction immediately before the first color printing according to the alignment execution flag set at the time of activation. The processor 121 executes the first color printing after executing the position misalignment correction, and proceeds to ACT16.

In a case of performing the first position misalignment correction (first color printing), the processor 121 determines whether a predetermined flag set time B has elapsed (ACT16). Here, the flag set time B is a time indicating a timing to set the alignment execution flag for executing the position misalignment correction at the time of the second color printing (immediately before). For example, the processor 121 sets the alignment execution flag in a case where the time B has elapsed since the first color printing accompanied by the position misalignment correction (the first alignment execution flag is turned off).

The processor 121 stands by until the flag set time B elapses after the first position misalignment correction is executed (ACT16, NO). The processor 121 accepts a request for printing including color printing until the flag set time B elapses after the first position misalignment correction is executed. In a case where color printing is requested until the flag set time B elapses after the first position misalignment correction is executed, the processor 121 executes color printing without the position misalignment correction.

In a case where the time B has elapsed from the execution of the first position misalignment correction (ACT16, YES), the processor 121 sets the alignment execution flag in order to execute the position misalignment correction in the next color printing (ACT17). For example, in a case where the flag set time B is set to 7 minutes as illustrated in FIG. 7, the processor 121 sets the alignment execution flag 7 minutes after the first color printing accompanied by the position misalignment correction.

If there is no color printing after activation (ACT14, NO), the processor 121 monitors whether a predetermined C time (flag settable period in which the second alignment execution flag can be set) has elapsed (ACT18). In a case where the predetermined C time has not elapsed (ACT18, NO), the processor 121 returns to ACT14. Furthermore, in a case where the predetermined C time has elapsed without color printing after activation (ACT18, YES), the processor 121 proceeds to ACT19 while maintaining the state of the alignment execution flag.

That is, in a case of executing the first position misalignment correction (color printing with position misalignment correction) within the flag settable period C, the processor 121 sets a second alignment execution flag at a timing indicated by the flag set time B. In a case where the position misalignment correction (color printing accompanied by the position misalignment correction) is not executed within the flag settable period C, the processor 121 holds the alignment execution flag set at the time of the activation operation.

In a case where the alignment execution flag is set with the flag set time B elapsed, or in a case where there is no color printing and a predetermined C time has elapsed (ACT18, YES), the processor 121 determines whether color printing has been received until a predetermined A time has elapsed (ACT19). In this case, upon receiving the execution request of the color printing (ACT19, YES), the processor 121 checks whether the alignment execution flag is set (ACT20).

In a case where the alignment execution flag is not set with the color printing received (ACT20, NO), the processor 121 further checks whether a normal alignment condition (a condition for executing position misalignment correction in a normal operation state) is satisfied (ACT21). In a case of determining that the alignment execution flag has not been set and the normal alignment condition is not satisfied (ACT21, NO), the processor 121 executes color printing and proceeds to ACT23.

In a case where the alignment execution flag is set (ACT20, YES), the processor 121 executes the position misalignment correction and turns off the alignment execution flag (ACT22). The processor 121 executes color printing received after executing the position misalignment correction, and proceeds to ACT23.

In a case where the normal alignment condition is satisfied (ACT21, YES), the processor 121 performs the position misalignment correction (ACT22). In this case, the processor 121 executes the received color printing, and proceeds to ACT23.

While repeating the processing of ACT19 to ACT22, the processor 121 monitors whether a predetermined A time (execution period of alignment execution control after activation) has elapsed (ACT23).

In a case where the predetermined A time has not elapsed (ACT23, NO), the processor 121 returns to ACT19 and repeatedly executes the above-described processing. In a case where the predetermined A time has elapsed (ACT23, YES), the processor 121 ends the alignment execution control after the activation (the period A after the activation).

As described above, the image forming apparatus according to the embodiment determines whether the difference value obtained by subtracting the environmental temperature from the temperature of the exposure apparatus until the start of printing immediately after power-on is equal to or larger than the predetermined threshold. In a case where the calculated difference value is a predetermined threshold or more, the image forming apparatus performs alignment execution control after activation. As the alignment execution control after activation, the image forming apparatus sets an alignment execution flag that instructs the next position misalignment correction in a case where a predetermined flag set time has elapsed from the first position misalignment correction after activation.

In addition, the image forming apparatus according to the embodiment determines whether the dump heater has operated during power-off (operation stop period) before power-on. In a case where the image forming apparatus determines that the dump heater has operated during power-off (operation stop period) before power-on, the image forming apparatus performs alignment execution control after activation.

According to the image forming apparatus of the embodiment, it is possible to perform the position misalignment correction before the image misalignment becomes large even in the second and subsequent color printing after activation due to the operation of the dump heater during the power-off. As a result, according to the image forming apparatus according to the embodiment, it is possible to provide a print result in which minute image misalignment after activation is suppressed to a user who desires high-quality color printing without color misalignment.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a plurality of image forming units configured to form a developer image obtained by developing a latent image formed on each of photoreceptors with a developer;
an exposure unit configured to output light for forming a latent image on each of the photoreceptors in the image forming units;
a transfer unit configured to transfer a superimposed image of the developer images formed by the image forming units to a medium; and
a processor configured to set an alignment execution flag that gives an instruction to execute next position misalignment correction with a predetermined flag set time elapsed after execution of first-cycle position misalignment correction after activation in a case where a difference between an environmental temperature during a period from activation to start of image formation and a temperature in the exposure unit satisfies a predetermined execution condition.

2. The image forming apparatus according to claim 1, further comprising:
an environment sensor configured to measure an environmental temperature; and
a temperature sensor configured to measure a temperature in the exposure unit,
wherein the predetermined execution condition is that a difference value obtained by subtracting a detection temperature of the environment sensor from a detection temperature of the temperature sensor is equal to or more than a predetermined temperature.

3. The image forming apparatus according to claim 1,
wherein the image forming units are configured to form developer images of respective colors forming color images, and
the position misalignment correction is processing of correcting a misalignment of the developer image of each color in color printing for forming a color image in which the developer images of the respective colors are superimposed.

4. The image forming apparatus according to claim 3,
wherein the processor is configured to execute the position misalignment correction immediately before color printing if the alignment execution flag is set in a case where the color printing is received.

5. The image forming apparatus according to claim 1,
wherein the processor is configured to set the alignment execution flag with a predetermined flag set time elapsed from the first-cycle position misalignment correction in a case where the first-cycle position misalignment correction is performed within a predetermined flag settable period after the activation.

6. The image forming apparatus according to claim 5,
wherein the processor is configured to set an alignment execution flag in an activation operation, turn off the alignment execution flag in a case where a first-cycle position misalignment correction is performed within the flag settable period after the activation, and set the alignment execution flag in a case where a predetermined flag set time has elapsed from the first-cycle position misalignment correction.

7. The image forming apparatus according to claim 6,
wherein in a case where the first-cycle position misalignment correction is not performed within the flag settable period, the processor is configured to hold the alignment execution flag set in the activation operation without performing the setting of the alignment execution flag based on the flag set time.

8. The image forming apparatus according to claim 5,
wherein the flag settable period is longer than the flag set time.

9. The image forming apparatus according to claim 5,
wherein the flag set time is shorter than an interval of the position misalignment correction in a normal operation state.

10. The image forming apparatus according to claim 5, further comprising
a memory including a rewritable storage area is configured to store a set value indicating the flag set time.

11. An image forming apparatus comprising:
a plurality of image forming units configured to form a developer image obtained by developing a latent image formed on each of photoreceptors with a developer;
an exposure unit configured to output light for forming a latent image on each of the photoreceptors in the image forming units;
a transfer unit configured to transfer a superimposed image of the developer images formed by the image forming units to a medium;
a heater provided in a housing of the image forming apparatus and configured to generate heat at a predetermined temperature or lower; and
a processor configured to set an alignment execution flag that gives an instruction to execute next position misalignment correction with a predetermined flag set time elapsed after execution of first-cycle position misalignment correction after activation in a case where the heater is turned on during an operation stop period before activation.

12. The image forming apparatus according to claim 11, further comprising:
an environment sensor configured to measure an environmental temperature; and
a temperature sensor configured to measure a temperature in the exposure unit,
wherein the predetermined execution condition is that a difference value obtained by subtracting a detection temperature of the environment sensor from a detection temperature of the temperature sensor is equal to or more than a predetermined temperature.

13. The image forming apparatus according to claim 11,
wherein the image forming units are configured to form developer images of respective colors forming color images, and
the position misalignment correction is processing of correcting a misalignment of the developer image of each color in color printing for forming a color image in which the developer images of the respective colors are superimposed.

14. The image forming apparatus according to claim 13,
wherein the processor is configured to execute the position misalignment correction immediately before color printing if the alignment execution flag is set in a case where the color printing is received.

15. The image forming apparatus according to claim 11,
wherein the processor is configured to set the alignment execution flag with a predetermined flag set time elapsed from the first-cycle position misalignment correction in a case where the first-cycle position misalignment correction is performed within a predetermined flag settable period after the activation.

16. The image forming apparatus according to claim 15,
wherein the processor is configured to set an alignment execution flag at a time of activation, turn off the alignment execution flag in a case where a first-cycle position misalignment correction is performed within the flag settable period after the activation, and set the alignment execution flag in a case where a predetermined flag set time has elapsed from the first-cycle position misalignment correction.

17. The image forming apparatus according to claim 16,
wherein in a case where the first-cycle position misalignment correction is not performed within the flag settable period, the processor is configured to hold the alignment execution flag set at the time of the activation without performing the setting of the alignment execution flag based on the flag set time.

18. The image forming apparatus according to claim 15,
wherein the flag settable period is longer than the flag set time.

19. The image forming apparatus according to claim 15,
wherein the flag set time is shorter than an interval of the position misalignment correction in a normal operation state.

20. The image forming apparatus according to claim 15, further comprising
a memory including a rewritable storage area configured to store a set value indicating the flag set time.
